(19) United States
(12) Patent Application Publication
(10) Pub. No.: US 2012/0174801 A1
(43) Pub. Date: Jul. 12, 2012

(54) TEPPANYAKI PLATFORM

(76) Inventor: TING-FANG CHIANG, Kaohsiung City (TW)

(21) Appl. No.: 12/986,925

(22) Filed: Jan. 7, 2011

(51) Int. Cl. A47J 37/00

(52) U.S. Cl. 99/357

(57) ABSTRACT

A teppanyaki platform comprises a platen, a stir-frying area disposed on the platen for stir-frying food, an eating area disposed around a periphery of the stir-frying area for users to dine, and a preparing area disposed between the stir-frying area and the eating area. By means of the separation brought about by the preparing area, the raw food and the cooked food would not be concurrently disposed on the stir-frying area, so that the raw food does not mix with the cooked food, and the dining hygiene is ensured. The arrangement of the preparing area and the eating area disposed in different horizontals renders the eating area and the stir-frying area more distinguishable for consumers to avoid mistakenly taking the raw food from the stir-frying area, so that the dining safety is increased, and the convenience of cleaning the dining plates is promoted.

### BACKGROUND OF THE INVENTION

1. Field of the Invention

The present invention relates to a kitchenware, particularly to a teppanyaki platform.

2. Description of the Related Art

Referring to FIG. 1, a conventional teppanyaki platform 1 comprises a platen 11, a stir-frying area 12 disposed on the platen 11 for cooking food, and an eating area 13 disposed on a periphery of the stir-frying area 12 for consumers to take food. Wherein, the stir-frying area 12 and the eating area 13 are disposed at the same level. Moreover, the uncooked food will be laid on a limited part on the stir-frying area 12 that is of a lower temperature, such as a part that is near a periphery of the eating area 13. Thereby, the uncooked food is capable of being preheated. In the meantime, pieces of aluminum foil or plates are spread on the stir-frying area 12 for laying cooked food. Preparing abovementioned arrangement, the cook further proceeds to cooking. Firstly, the raw food is moved to a part of the stir-frying area 12, which is of a higher temperature (such as a center of the stir-frying area 12), for being cooked. Subsequently, the cooked food is served and laid on the aluminum foil for consumers to further move the food toward their plates disposed on the eating area 13 for eating.

Obviously, both the raw food and the cooked food are in fact laid on the stir-frying area 12. Thus, while cooking, the chef has to avoid the gravy generated during frying accidentally spraying toward the cooked food. Otherwise, the cooked food is subject to contamination by the germs remained on the raw food, which causes the concern of hygiene. Accordingly, the concurrent dispositions of the raw food and the cooked food on the stir-frying area 12 may influence the culinary skill of the chef to some extend, and thence the taste of the food is also somewhat affected. Further, the cooked food is placed on the aluminum foil that is quite near where the raw food is put. Namely, the cooked food and the raw food are in fact placed on the same region, the stir-frying area 12. As a result, consumers might carelessly take the raw food on the stir-frying area 12, and the raw food would be thence mistakenly eaten. Adversely, the cautious consumers may pay attention on the differences between the raw food and the cooked food all the time during the meal. Therefore, the careful consumers may not enjoy their meal of the teppanyaki. Thus, the conventional disadvantages need to be amended.

### SUMMARY OF THE INVENTION

It is therefore the purpose of this invention to provide a teppanyaki platform that improves the hygiene while eating and promotes the convenience while dinning.

The teppanyaki platform in accordance with the present invention comprises a platen, a stir-frying area disposed on the platen for cooking food, an eating area disposed around a periphery of the stir-frying area for users to meal, and a preparing area disposed between the stir-frying area and the eating area. Characterized in that, the preparing area and the eating area are set on different horizontals. Accordingly, in time of dinning, consumers are able to clearly distinguish the raw food from the cooked food since the stir-frying area, the eating area, and the preparing area are respectively arranged with different horizontals. Further, the raw food not mixing with the cooked food, the hygienic concern is solved. Moreover, the cooked food that is ready to be served will be placed on the preparing area, thereby preventing the cooked food from being sprayed by the gravy generated from the frying food since a certain distance is reserved for spraying. As a result, the cooked food is not contaminated by the germs existing in the raw food or in the frying gravy. Thereby, the dining hygiene is promoted.

Preferably, a reminding area is disposed between the eating area and the preparing area.

Preferably, the horizontal of the preparing area is higher than the horizontal of the eating area.

### BRIEF DESCRIPTION OF THE DRAWINGS

FIG. 1 is a schematic view showing a conventional teppanyaki platform;

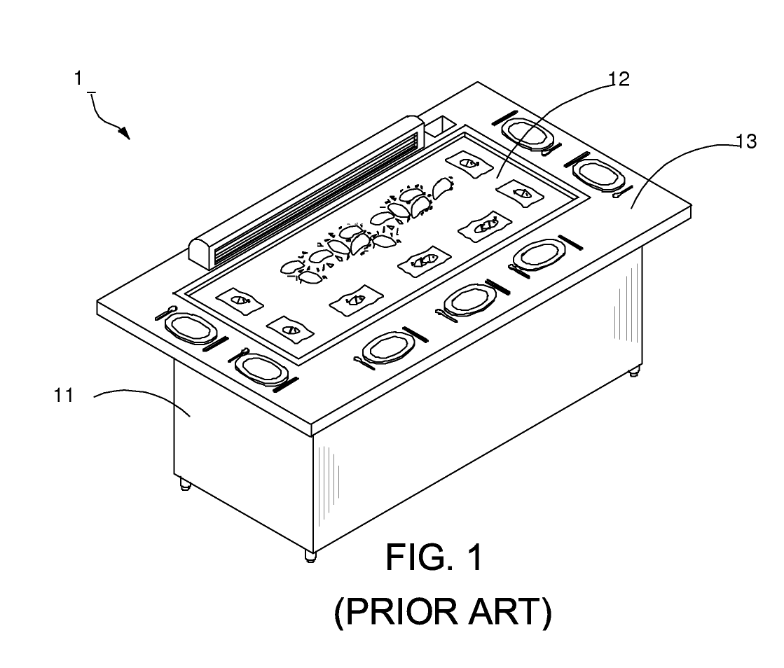

FIG. 2 is a perspective view showing a first preferred embodiment of the present invention;

FIG. 3 is a perspective view showing the first preferred embodiment of the present invention in using; and

FIG. 4 is a perspective view showing a second preferred embodiment of the present invention.

### DETAILED DESCRIPTION OF THE PREFERRED EMBODIMENTS

Wherever possible, the same reference numbers are used in the drawings and the description to refer to the same or like parts.

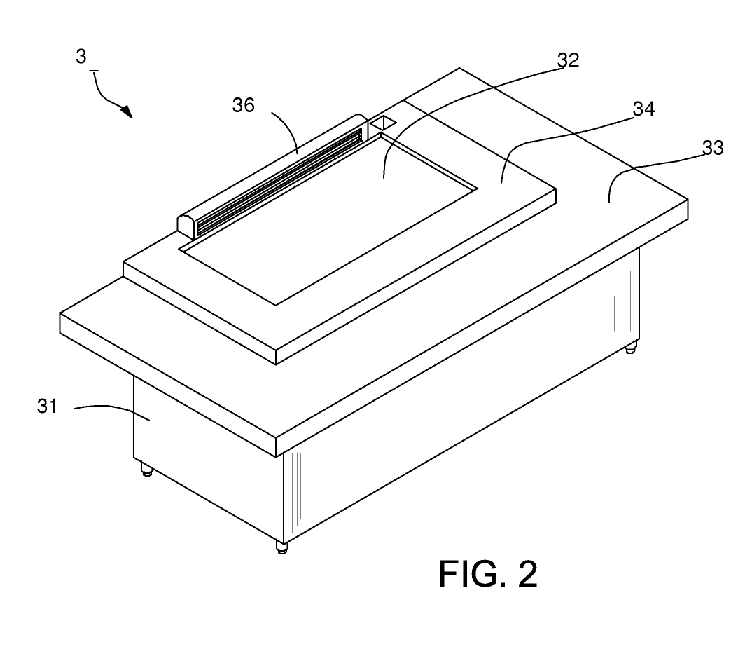

Referring to FIG. 2, a first preferred embodiment of the present invention is shown. A teppanyaki platform 3 comprises a platen 31, a stir-frying area 32 disposed on the platen 31 for cooking food, an eating area 33 disposed around a periphery of the stir-frying area 32 for users to meal, and a preparing area 34 disposed between the stir-frying area 32 and the eating area 33. Preferably, an exhaust fan 36 is disposed on the platen 31 for exhausting the cooking fumes generated while stir-frying on the stir-frying area 32. Further, the horizontal of the preparing area 34 is different from the horizontal of the eating area 33. Herein, the horizontal of the preparing area 34 could be either higher or lower than the horizontal of the eating area 33. In this embodiment, the horizontal of the preparing area 34 is higher than the horizontal of the eating area 33.

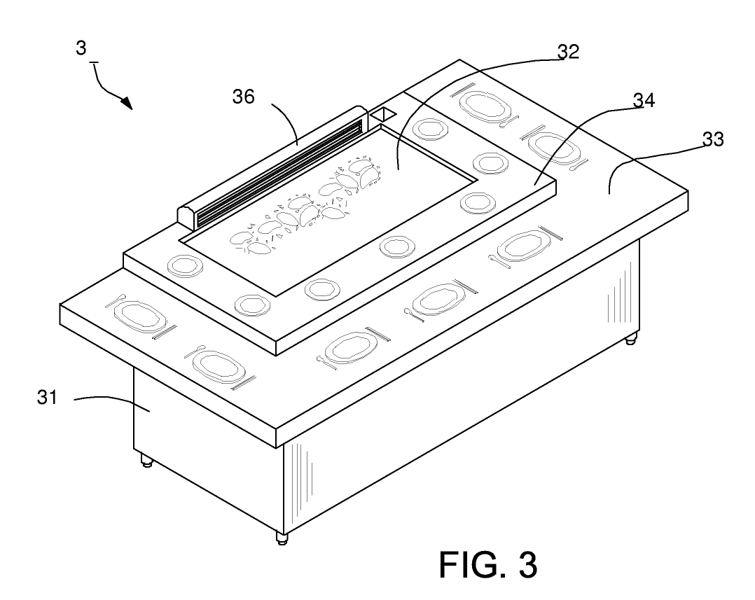

Referring to FIG. 3, in operation, a chef firstly places the raw food on one part of the stir-frying area 32 in a lower temperature, such as a place near the preparing area 34. While cooking, the raw food is moved to the other part of the stir-frying area 32 in a higher temperature, such as a center of the stir-frying area 32. Accordingly, the cooked food that is ready to be served will be transferred to the preparing area 34. Thereby, consumers are able to directly take the cooked food from the preparing area 34 and eat. Thus, the raw food is distinguished from the cooked food by means of the preparing area 34 to avoid laying the two food on the same place. Further, the cooked food is not contaminated by the raw food, so the dining hygiene is promoted. Obviously, the preparing area 34 provides a certain distance between the cooked food and the stir-frying food on the stir-frying area 32. That is to say, the chance that the cooked food is sprayed by the gravy generated while stir-frying the raw food is decreased. Therefore, the chef could freely perform his culinary skill since he does not have to pay attention on the spurting gravy from the raw food all the time. Moreover, by means of the higher preparing area 34, consumers are able to easily differentiate the raw food from the cooked food. Thus, the chance that consumers mistakenly take the uneatable food to eat is also reduced. Therefore, the dining safety of consumers is assured.

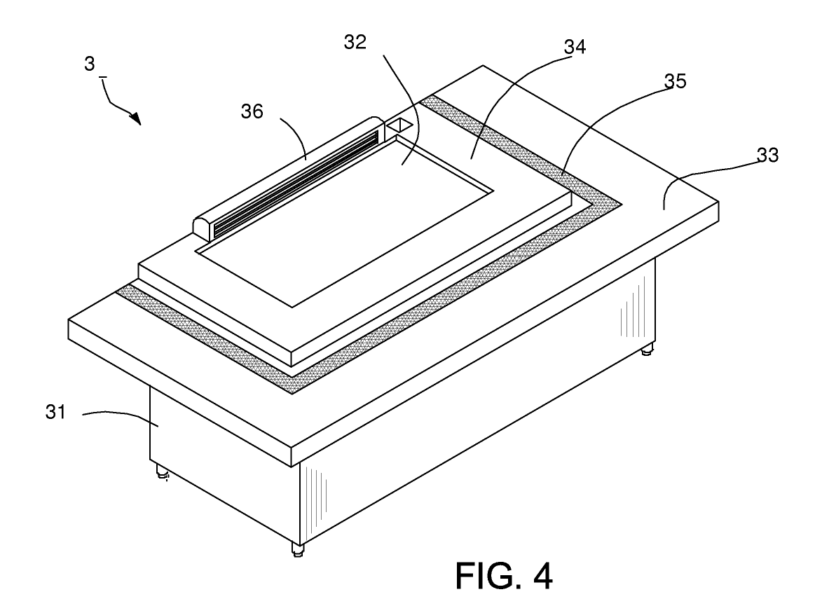

Referring to FIG. 4, a second preferred embodiment of the present invention is shown. The teppanyaki platform 3 still comprises the same elements and achieves the similar functions like that of the first preferred embodiment. The like correlations between the platen 31, the stir-frying area 32, the eating area 33, the preparing area 34, and the exhaust fan 36 are herein omitted. Differently, a reminding area 35 is alternatively disposed between the eating area 33 and the preparing area 34. Preferably, the reminding area 35 could adopt an illuminator or a decorative strip. In this embodiment, the reminding area 35 adopts an illuminator. Accordingly, by means of the disposition of the reminding area 35 between the eating area 33 and the preparing area 34, the eating area 33 further emerges from the preparing area 34 so as to allow consumers to be conscious of the eating area 33. Favorably, the reminding area 35 further serves as a demarcation line for the staff to arrange the plates in order. Thus, the plates could be placed neatly and tidily, which increases the convenience of cleaning the plates.

To sum up, the present invention particularly utilizes the preparing area for laying the cooked food to avoid the concurrent dispositions of the cooked food and the raw food on the stir-frying area. Preferably, the dining hygiene is ensured. In addition to the preparing area and the eating area of the different horizontals, consumers are able to well differentiate the raw food from the cooked food. Thus, the consumers do not mistakenly take the raw food from the stir-frying area anymore. Thereby, the dining safety is also guaranteed.

While we have shown and described the embodiment in accordance with the present invention, it should be clear to those skilled in the art that further embodiments may be made without departing from the scope of the present invention.

I claim:

1. A teppanyaki platform comprising a platen, a stir-frying area disposed on said platen for cooking food, and an eating area disposed around a periphery of said stir-frying area for users to meal;
characterized in that, a preparing area is disposed between said stir-frying area and said eating area; said preparing area and said eating area being set on different horizontals.

2. The teppanyaki platform as claimed in claim 1, wherein, a reminding area is disposed between said eating area and said preparing area.

3. The teppanyaki platform as claimed in claim 1, wherein, the horizontal of said preparing area is higher than the horizontal of said eating area.
